(19) United States
(12) Patent Application Publication
(10) Pub. No.: US 2018/0000137 A1
(43) Pub. Date: Jan. 4, 2018

(54) METHOD FOR PREPARING A FLOUR OF LIPID-RICH CRUSHED MICROALGAE

(71) Applicant: Roquette Freres, Lestrem (FR)

(72) Inventor: Damien Passe, Douai (FR)

(73) Assignee: Roquette Freres, Lestrem (FR)

(21) Appl. No.: 15/546,254

(22) PCT Filed: Jan. 22, 2016
(86) PCT No.: PCT/FR2016/050127

§ 371 Date: Jul. 25, 2017

(30) Foreign Application Priority Data
Jan. 26, 2015 (FR) 15 50584

(51) Int. Cl. A23L 7/10; A23L 17/60; A23L 33/195; A23L 33/115

(52) U.S. Cl. CPC A23L 7/198; A23L 33/115; A23L 17/60; A23L 33/195; A23V 2002/00

(57) ABSTRACT

The invention relates to a method
for preparing a lipid-rich microalgal flour, which comprises the following steps:
(a) providing a microalgal biomass comprising more than 50% of lipids by dry weight of biomass;
(b) lyzing the microalgae,
(c) concentrating the microalgal lyzate to a solids content of more than 25% by weight, preferably to a solids content of between 35% and 50% by weight,
(d) applying a heat treatment to the lyzate thus concentrated,
(e) homogenizing at high pressure the lyzate obtained in step (d), so as to obtain a stable emulsion,
(f) drying said emulsion to obtain the microalgal flour.

The present invention relates to a method for preparing a lipid-rich flour of milled microalgae, the microalgae being of the genus Chlorella, more particularly Chlorella protothecoides, from a biomass with a high solids content.

It is well known to those skilled in the art that microalgae of the genus Chlorella are a potential source of food, since they are rich in protein and other essential nutrients.

On average, they contain 45% protein, 20% fat, 20% carbohydrate, 5% fiber and 10% minerals and vitamins.

The oil fraction of the Chlorella biomass, which is composed essentially of monounsaturated oils, thus provides nutritional and health advantages compared with the saturated, hydrogenated and polyunsaturated oils often found in conventional food products.

Chlorellae are thus exploited in human or animal nutrition:
either in the form of whole biomass,
or in the form of flour, obtained by drying the biomass of chlorellae whose cell wall has been broken in particular by mechanical means.

The microalgal flour also provides other benefits, such as micronutrients, dietary fiber (soluble and insoluble carbohydrates), phospholipids, glycoproteins, phytosterols, tocopherols, tocotrienols and selenium.

In order to prepare the biomass which will be incorporated into the food composition, the biomass is harvested from the culture medium (culturing by photoautotrophy in photobioreactors, or heterotrophically in darkness and in the presence of a source of carbon which can be assimilated by the chlorellae). Heterotrophic growth of the chlorellae is preferred (referred to as the fermentation route).

At the time of the harvesting of the microalgal biomass from the fermentation medium, the biomass comprises intact cells which are mostly in suspension in an aqueous culture medium.

In order to concentrate the biomass, a solid-liquid separation step is then performed by frontal or tangential filtration, by centrifugation or by any means additionally known to those skilled in the art.

The microalgal biomass thus isolated may be treated directly in order to produce vacuum-packed cakes, algal flakes, algal homogenates, intact algal flour, milled algal flour or algal oil.

The intact whole microalgal biomass is also dried in order to facilitate the subsequent treatment or for use of the biomass in its various applications, in particular food applications.

The microalgal biomass is primarily upgraded in the form of a lipid-rich microalgal flour, in the form of milled dried cellular material.

Conventionally, the lipid-rich microalgal flour is prepared from a biomass containing from about 20 to 25% solids, in the following manner:
collection of the microalgae separated from their growth medium,
rupture of the cells so as to release the molecules of interest therefrom,
adjustment of the pH to a value of between 6.5 and 7.5,
pasteurization and washing,
drying.

The first step of collecting the cells is performed by implementing one or more solid/liquid separation steps.

The biomass is usually collected by sedimentation, centrifugation or filtration, and sometimes an additional flocculation step is necessary.

In the second step of cell rupture, several routes are possible: mechanical (homogenizers, bead mill or ultrasonication) or non-mechanical (alkaline route, freezing/thawing cycles, organic solvents or osmotic shocks).

The choice of the method depends especially on the nature of the cell wall of the microalga to be ruptured.

The lipid-rich microalgal flour is then prepared from a microalgal biomass conventionally having a solids content of not more than 25%, which has been mechanically lyzed and homogenized, the homogenate then being atomized or flash-dried.

To obtain this microalgal lyzate mechanically, a pressure disruptor may be used, for example, to pump a suspension containing the microalgal cells through a restricted orifice so as to lyze the cells.

A high pressure (up to 1500 bar) is applied, followed by an instantaneous expansion through a nozzle.

The cells can be lyzed (or milled) by three different mechanisms: running into the valve, high shear of the liquid in the orifice, and a sudden drop in pressure at the outlet, causing the cell to explode.

A Niro homogenizer (GEA Niro Soavi) or any other high-pressure homogenizer may be used to treat the cells having a size predominantly between 0.2 and 5 microns.

This treatment of the algal biomass under high pressure (several treatments at approximately 1000 bar) generally lyzes more than 90% of the cells and reduces the size to less than 5 microns.

Alternatively, a bead mill is rather used to obtain the microalgal lyzate.

In a bead mill, the cells are agitated in suspension with small spherical particles. Rupture of the cells is caused by the shear forces, the milling between the beads, and the collisions with beads.

These beads rupture the cells so as to release the cell content therefrom. The description of an appropriate bead mill is, for example, given in the patent U.S. Pat. No. 5,330,913.

A suspension of particles of smaller size than the cells of origin is then obtained, said suspension being in the form of an “oil-in-water” emulsion.

This emulsion is then spray-dried and the water is eliminated, leaving a dry powder containing the cell debris, intracellular liquid and oil.

In the third step, a pH adjustment is then made to stabilize the cell extract obtained.

The pasteurization of the fourth step consists of a heat treatment conventionally performed at high temperature for a short time (HTST, or ultra-high temperature, UHT), for example at 140° C. for 6 seconds.

As regards the washing, it allows the soluble impurities to be removed.

The final step of the downstream treatment consists in dehydrating said suspension (lyzed cells). Several methods have been employed for drying microalgae of the genera Chlorella, Scenedesmus and Spirulina. The most conventional are atomization, drying on a drying drum and lyophilization, preferably in the presence of antioxidants. Atomization is the method most often used at the industrial scale.

However, according to this conventional method, since the microalgal biomass contains oil in a content of 50% by weight or more, it is necessary to limit the solids content of the microalgal biomass which will then be lyzed.

Specifically, when produced from a lipid-rich biomass (oil) with a high solids content, the suspension of lyzed cells will have a natural tendency to undergo phase separation.

It is even difficult to obtain a lipid-rich microalgal flour if the starting material used is a biomass with a solids content of more than 25% and especially more than 28%, or is even impossible if the solids content of the biomass exceeds 35%.

Specifically, at a solids content of more than 35%, the regrettable formation of a coalescence of oil droplets takes place on the evaporation devices used before the atomization step, for the manufacture of the flours (device such as a Rotavapor®) when a milled material of lipid-rich microalgal biomass is handled.

The “oil-in-water” emulsion thus obtained is then unstable and therefore cannot be dried efficiently since it leads to the formation of a tacky “butter” texture.

It however appears to be more economical, with regard to the volumes to be treated at the industrial level, to use a method for preparing microalgal flour from a biomass with a solids content of more than 25%.

### SUBJECT OF THE INVENTION

There is thus still an unsatisfied need for a method for preparing a lipid-rich microalgal flour which does not necessitate working at a low solids content.

After extensive research, the Applicant company has found that this need can be met by providing a method for preparing a lipid-rich microalgal flour, which comprises the following steps:

(a) providing a microalgal biomass comprising more than 50% of lipids by dry weight of biomass;

(b) lyzing the microalgae,

(c) concentrating the microalgal lyzate to a solids content of more than 25% by weight, preferably to a solids content of between 35% and 50% by weight,

(d) applying a heat treatment to the microalgal lyzate thus concentrated,

(e) homogenizing at high pressure the concentrated lyzate thus obtained so as to obtain a stable emulsion,

(f) drying said emulsion to obtain the microalgal flour.

For the purposes of the present invention, the term “lipid-rich” means containing more than 50% of lipids.

For the purposes of the present invention, the term “stable emulsion” refers to the absence of phase separation of the oil and water phases.

In accordance with the invention, in step (a), the microalgae under consideration are preferably microalgae of the Chlorella genus, more particularly Chlorella protothecoides, even more particularly Chlorella deprived of chlorophyll pigments, by any method known per se to those skilled in the art (either because the culturing is performed in the dark under certain operating conditions well known to those skilled in the art, or because the strain has been mutated so as to no longer produce these pigments).

The microalgal biomass is a biomass preferentially prepared by fermentation, under heterotrophic conditions and in the absence of light, of a microalga of the Chlorella genus, preferably Chlorella protothecoides.

The fermentation conditions are well known to those skilled in the art. The appropriate culture conditions to be used are in particular described in the article by Ikuro Shihira-Ishikawa and Eiji Hase, “Nutritional Control of Cell Pigmentation in Chlorella protothecoides with special reference to the degeneration of chloroplast induced by glucose”, Plant and Cell Physiology, 5, 1964.

Other articles, such as the one by Han Xu, Xiaoling Miao, Qingyu Wu, “High quality biodiesel production from a microalga Chlorella protothecoides by heterotrophic growth in fermenters”, Journal of Biotechnology, 126, (2006), 499-507, indicate that heterotrophic culture conditions, i.e. in the absence of light, make it possible to obtain an increased biomass with a high content of lipids in the microalgal cells.

The solid and liquid growth media are generally available in the literature, and the recommendations for preparing the particular media which are suitable for a large variety of microorganism strains can be found, for example, online at www.utex.org/, a website maintained by the University of Texas at Austin for its algal culture collection (UTEX).

In the light of their general knowledge and the abovementioned prior art, those skilled in the art responsible for culturing the microalgal cells will be entirely capable of adjusting the culture conditions in order to obtain a suitable biomass, preferably rich in lipids.

The production of biomass is performed in fermenters (or bioreactors). The specific examples of bioreactors, the culture conditions, and the heterotrophic growth and methods of propagation can be combined in any appropriate manner in order to improve the efficiency of the microbial growth and of the lipids.

In one particular embodiment, the fermentation is performed in fed-batch mode with a glucose flow rate adjusted so as to maintain a residual glucose concentration of from 3 to 10 g/l.

During the glucose feed phase, the nitrogen content in the culture medium is preferably limited so as to allow the accumulation of lipids in an amount of 30%, 40%, 50% or 60%. The fermentation temperature is maintained at a suitable temperature, preferably between 25 and 35° C., in particular 28° C. The dissolved oxygen is preferably maintained at a minimum of 30% by controlling the aeration, the counter-pressure and the stirring of the fermenter.

Preferably, the biomass obtained, which is thus useful in the present invention, has a solids content of at least 20%, preferably between 20% and 40%, with a lipid content of more than 50% by dry weight.

For example, the biomass used in the method that is the subject of the present invention has a solids content of at least 20%, preferably between 20% and 40% and with a lipid content of more than 50% by dry weight, a fiber content of from 10% to 50% by dry weight, a protein content of from 2% to 15% by dry weight and a sugar content of less than 10% by weight.

In accordance with the invention, in step (b), the biomass cells used for the production of microalgal flour are lyzed in order to release their oil or lipids.

The cell walls and the intracellular components are milled or reduced, for example using a bead mill, to non-agglomerated cell particles or debris.

In the mill, the cells are agitated in suspension with small beads. Rupture of the cells is caused by the shear forces, the milling between the beads, and the collisions with beads. In fact, these beads rupture the cells so as to release the cell content therefrom. The description of an appropriate bead mill is, for example, given in the patent U.S. Pat. No. 5,330,913.

Preferably, antioxidants are added to the biomass before performing the lysis.

A microalgal lyzate in the form of a particle suspension in the form of an “oil-in-water” emulsion is thus obtained.

In accordance with the invention, in step (c), the lyzate is concentrated so as to obtain a lyzate with a solids content of more than 25% by weight, preferably between 35% and 50% by weight.

This concentration is preferably performed by evaporating off the water at high temperature, and not by centrifugation.

The evaporator used is preferably:
a falling-film evaporator for a biomass with a solids content of not more than 33%,
a forced-flow evaporator for a biomass with a solids content of between 20 and 45%,

under the following conditions:
flash inlet temperature: between 60 and 75° C., preferably 68° C.
temperature in the flash: between 35 and 60° C., preferably 40° C.
recirculation flow rate: between 25 and 45 m³/h, preferably 40 m³/h.

In accordance with the invention, in step (d), the concentrated lyzate is heat-treated. This heat treatment especially allows deoxygenation/deodorization of the lyzate with a high solids content.

Preferably, step (d) is performed at high temperature for a short time (HTST, or ultra-high temperature, UHT), for example at 140° C. for 6 seconds.

In accordance with the invention, step (e) consists in homogenizing the lyzate obtained on conclusion of step (d), so as to generate a stable oil-in-water emulsion, despite the high solids content of said lyzate.

This homogenization is preferably performed in a two-stage device, for example a Gaulin homogenizer sold by the company APV, with a pressure:
of between 150 and 170 bar, preferably 160 bar in the first stage, and
of between 35 and 45 bar, preferably 40 bar in the second stage.

In accordance with the invention, the final step (step f) consists in drying the emulsion to obtain the microalgal flour.

The drying is preferably performed by atomization. On conclusion of this step during which the water is removed, a dry powder containing the cell debris and the lipids is obtained.

After drying, the water content or the moisture content of the powder is generally less than 10%, preferentially less than 5%.

Optionally, a pH adjustment of the lyzate before the heat treatment step may be performed.

By virtue especially of the heat treatment followed by high-pressure homogenization of the lyzate, the method that is the subject of the present invention advantageously makes it possible to obtain a lipid-rich milled microalgal flour from a biomass of microalgae, especially of chlorellae, containing more than 50% of lipids and having a solids content of at least 20%.

1. A method for preparing a lipid-rich microalgal flour, comprising
(a) providing a microalgal biomass containing more than 50% of lipids by dry weight of biomass;
(b) lyzing the microalgal to for a microalgal lyzate,
(c) concentrating the lyzate to a solids content of more than 25% by weight, preferably to a solids content of between 35% and 50% by weight,
(d) heating the concentrated lyzate,
(e) homogenizing at high pressure the lyzate obtained in step (d), so as to obtain a stable emulsion,
(f) drying said emulsion to obtain the microalgal flour.

2. The method as claimed in claim 1, wherein the microalga is of the genus Chlorella.

3. The method according to claim 1, wherein the concentration of the microalgal lyzate is performed by evaporation.

4. The method as claimed in claim 3, wherein the concentration of the lyzate is performed at high temperature in an evaporator under the following conditions:
flash inlet temperature: between 60 and 75° C.,
temperature in the flash: between 35 and 60° C.,
recirculation flow rate: between 25 and 45 m³/h.

5. The method according to claim 1, wherein the high-pressure homogenization is performed in a two-stage device, with a pressure:
of between 150 and 170 bar in a first stage, and
of between 35 and 45 bar in a second stage.

6. The method according to claim 1, wherein said emulsion is dried by atomization.

7. The method as claimed in claim 1, wherein the microalga comprises Chlorella protothecoides.

8. A method for preparing a lipid-rich microalgal flour, comprising which comprises the following steps comprising
(a) lyzing a Chlorella microalgal biomass containing more than 50% of lipids by dry weight of biomass to form a lyzate,
(b) evaporating water in said lysate to a solids content 35% and 50% by weight, to form a concentrate,
(c) heating the concentrate deoxygenate and/or deodorize the concentrate,
(d) forming a stable oil-in-water lysate emulsion, and
(e) drying said emulsion to obtain the microalgal flour.
